(19) United States
(12) Patent Application Publication
(10) Pub. No.: US 2004/0017074 A1
(43) Pub. Date: Jan. 29, 2004

(54) Personal information recording system

(76) Inventor: Patrice L. McMorrow, Fanwood, NJ (US)

Correspondence Address: WOLFF & SAMSON, P.C., ONE BOLAND DRIVE, WEST ORANGE, NJ, 07052, US

(21) Appl. No.: 10/205,191

(22) Filed: Jul. 25, 2002

(51) Int. Cl. B42D 15/00

(52) U.S. Cl. 283/62

(57) ABSTRACT

A personal information recording system is provided for recording information about a person's life, such as events in a child's life. A plurality of information sheets that are stepped in size and tiered are formatted to allow personal information to be recorded thereon. One or more folders may be provided for storing the plurality of sheets and other memorabilia, such as cards, invitations, and other objects. A storage packet allows the sheets and/or folders to be stored therein. The storage packet may include a plurality of external pockets for storing writing instruments or other objects. An attachment mechanism is provided for attaching the storage packet to a surface.

### BACKGROUND OF THE INVENTION

1. Field of the Invention

The present invention relates to a system for documenting memorable events in a person's life. More specifically, the invention relates to a system that can be used by gathering materials and recording information such as milestones, experiences and achievements in a person's life, particularly a child.

2. Related Art

Many parents seek to document, in writing, the memorable events in a child's young life, especially all of the “firsts” that infants accomplish (e.g. first smile, word, step). Despite the numerous baby journals that are commercially available, many lack the ease of use that busy, time-restricted parents desire. For instance, many baby books are lengthy and thus overwhelming to complete; they are usually tucked away for safe keeping, rendering them inaccessible and inconvenient for quick updates. Also, unless retrieved and opened, the contents of a bound book are hidden from plain view. As a result, the information contained within its pages cannot serve as reminders to parents of the subsequent developmental milestones to look for and document as their child matures. With the aforementioned in mind, many baby books are never completed leaving parents with a strong sense of disappointment and guilt over their failure to provide a child with a keepsake that chronicles his/her development from the parent's perspective.

Parents may also desire a convenient and central location to easily and securely store or retrieve the various cards, invitations, health records, and other memorabilia that their child acquires. Often parents insert such items haphazardly within the front or back cover of a journal. As a result, the articles are frequently lost, misplaced, or tattered. Although some publishers have integrated envelope enclosures within the body of their books, a parent must first locate and retrieve the journal, making the filing of the materials a time-consuming and inconvenient exercise.

A variety of calendar-related products have been designed and/or produced in an attempt to abbreviate and simplify the recording of the aforementioned personal information; however, they are generally limited in the amount, organization, and presentation of such information.

In addition, these past designs have also failed to recognize that the time restrictions on parents are intensified when caring for multiples (twins, triplets, etc.) or when a newborn represents the 2^{nd}, 3^{rd}, or 4^{th} addition to a family.

As a result, what would be desirable, but has not heretofore been provided, is a personal information recording system that is efficient, convenient, and accessible to parents for their use in documenting the milestones, experiences, and achievements of their children.

### OBJECTS AND SUMMARY OF THE INVENTION

It is an object of the present invention to provide a personal information recording system that can be placed in a central, convenient and easily accessible location.

It is still another object of the present invention to provide a personal information recording system that includes a plurality of sheets for recording information about specific events in a person's life.

It is even an additional object of the present invention to provide a personal information recording system wherein the plurality of sheets are stepped in or tiered to allow for easy visibility of and access to the sheets.

It is another object of the present invention to provide a personal information recording system capable of storing records and memorabilia such as cards, invitations, etc.

It is still another object of the present invention to provide a personal information recording system having a storage packet with a primary pocket one or more supplemental pockets for holding a writing instrument and/or other items.

It is a further object of the present invention to provide a personal information recording system that includes an apparatus for attaching the storage packet to a surface, typically a vertical surface such as a refrigerator, cabinet, or other surface, wherein the storage packet can be removed from the surface without causing damage thereto.

The present invention relates to a personal information recording system for recording personal information and events occurring in a person's life. The invention provides an accessible, convenient, and flexible recordation system, and comprises a plurality of sheets, and a storage packet for storing the sheets. A supplemental pocket may be provided for a writing instrument. A mechanism for attaching the storage packet to a desired location on a surface such as a refrigerator door, cabinet, or other surface, may also be included. One or more folders may be included for storing the sheets and other records and/or memorabilia such as cards, invitations, etc.

The sheets of the present invention can be pre-formatted to facilitate the recording of information pertaining to specific events in a person's life, such a baby's “firsts.” The sheets are preferably stepped in size and tiered so that subject headings of each sheet are visible when the sheets are stored in the packet or in a folder, allowing an individual to quickly and conveniently locate a desired sheet and retrieve same to add information thereto. A folder may include a pocket for storing records and memorabilia relating to events, such as cards, invitations, etc., or same may be placed directly in the storage packet. One or more folders can be stored in the storage packet, which can be attached to an accessible surface. Archival quality materials can be used to construct the storage packet, folders, and sheets.

### BRIEF DESCRIPTION OF THE DRAWINGS

These and other important objects and features of the invention will be apparent from the following Detailed Description of the Invention taken in connection with the accompanying drawings in which:

FIG. 1 is a front view of stepped sheets of the present invention for recording personal information.

FIG. 2 is a perspective view of a folder of the present invention for storing the sheets and other memorabilia.

FIG. 3 is a perspective view showing the sheets and the folder of the present invention, the sheets positionable in the folder as shown by the arrow.

FIG. 4 is a front view of the storage packet of the present invention.

FIG. 5 is a front view showing the folder and the storage packet of the present invention, the folder positionable in the storage packet as shown by the arrow.

FIG. 6 is a rear view of the storage packet of the present invention.

FIGS. 7a-7b are views of the front and back sides of a representative sheet of the present invention, entitled “Welcome to the World.”

FIGS. 8a-8b are views of the front and back sides of another representative sheet of the present invention, entitled “Milestones and Memories.”

FIGS. 9a-9b are views of the front and back sides of another representative sheet of the present invention, entitled “My, how you've grown.”

FIGS. 10a-10b are views of the front and back sides of another representative sheet of the present invention, entitled “Your 1^{st} year, on-the-fly,” months 1-4.

FIGS. 11a-11b are views of the front and back sides of another representative sheet of the present invention, entitled “Your 1^{st} year, on-the-fly,” months 5-8.

FIGS. 12a-12b are views of the front and back sides of another representative sheet of the present invention, entitled “Your 1^{st} year, on-the-fly,” months 9-12.

### DETAILED DESCRIPTION OF THE INVENTION

The present invention relates to a personal information recording system for recording and storing information and associated items about a person's life, such as a child's life. A plurality of sheets, preferably stepped in size and tiered, allow information about specific events, such as a child's birth and development, to be recorded thereon. The sheets can be stacked together and stored in a folder, wherein subject headings of each of the sheets remain visible for quick location and access by a user. The folder could include a pocket for storing additional memorabilia, such as cards, invitations, etc. One or more folders can be stored in a storage packet that provides protection from spills and damage. Alternatively, the sheets and/or records and/or memorabilia can be placed directly into the storage packet, thereby eliminating the need for a folder. Writing instruments, such as pens or pencils, can be stored in one or more pockets that may be affixed to the storage packet. The storage packet can include a mechanism for attaching same to a surface, typically a vertical surface such as a refrigerator, wall or a cabinet door. Alternatively, the storage packet could be used without any attachment to a surface.

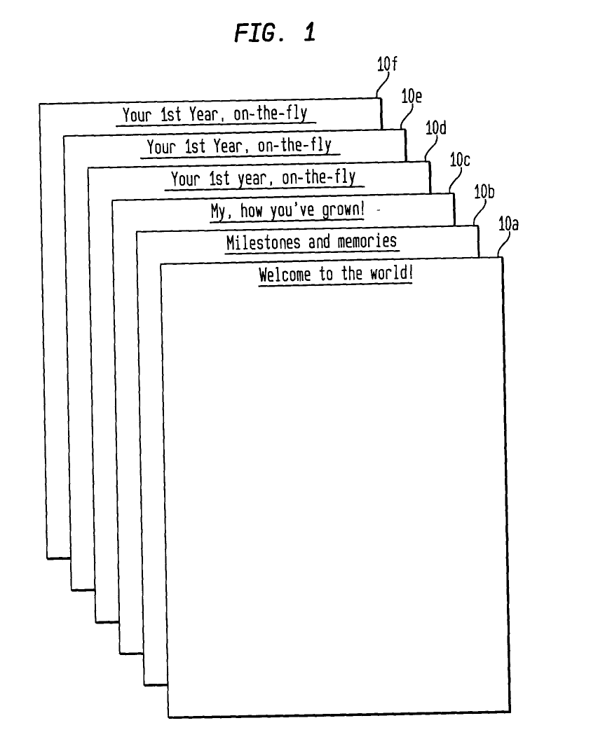

FIG. 1 is a perspective view of the sheets of the present invention for recording personal information. The information sheets, indicated collectively at 10 and individually at 10a-10f, allow for the recordation of information. Preferably, information sheets 10 are used to record personal information about events in a person's life, such as the birth and development of a child. An individual can write on each of the information sheets 10 using a writing instrument to record desired information. Information sheets 10 may include markings, headings, word prompts, spaces, or other indicia pertinent to the information to be recorded for facilitating thorough and orderly recording of information. In a preferred embodiment, information sheets 10 are manufactured from archival-quality paper to provide long life, but any known material that is resilient and capable of being written on is considered within the scope of the present invention.

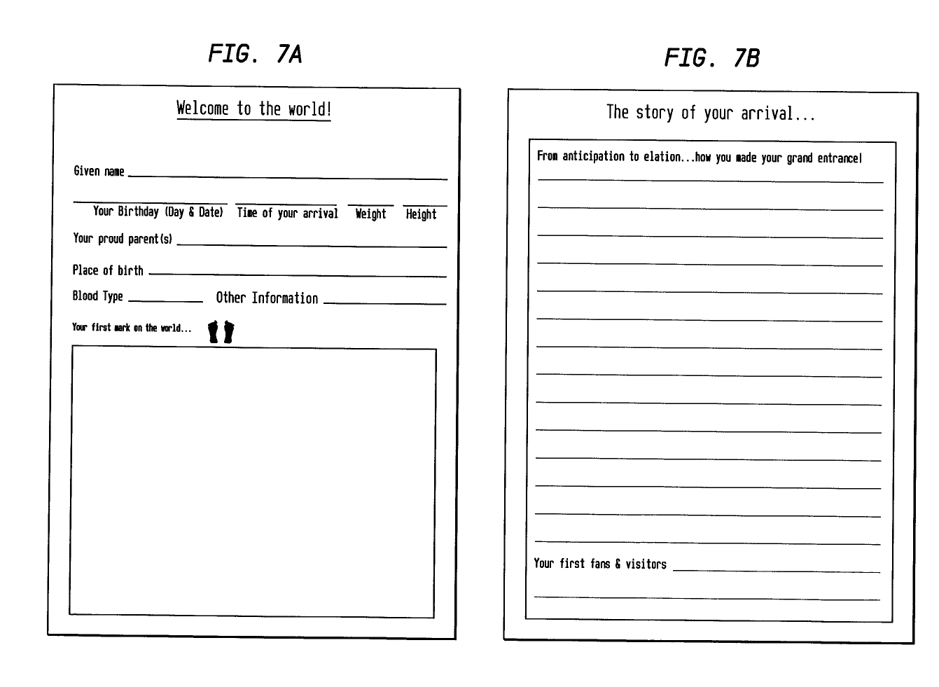

As shown in FIG. 1, information sheets 10a-10f may be stepped in size, or tiered, so that the tiered portions of information sheets 10a-10f are visible when the sheets are stacked together. The tiers could be formed at the upper edges or side edges of the sheets. In a preferred embodiment of the present invention, the tiered portions of each of the information sheets 10a-10f contain a heading or other marking that indicates the general subject matter of each information sheet. For example, information sheet 10a could contain a heading entitled “Welcome to the world!” to identify information on information sheet 1Oa relating to the birth of a child. Further, information sheets 10b-10f could contain headings relating to the development of the child, ordered chronologically. Any conceivable heading or marking may be used on each of information sheets 10a-10f, and the sheets could be set up to record any conceivable information about any conceivable subject matter. The contents of individual information sheet 10a-10f will be discussed hereinafter in greater detail, with reference to FIGS. 7a-12b.

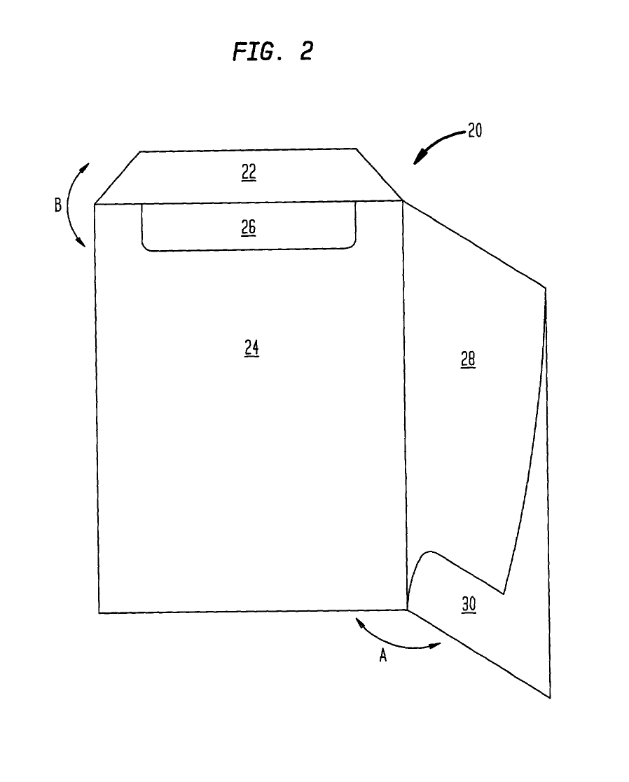

FIG. 2 is a perspective view of a folder of the present invention that may be used for storing the sheets and other memorabilia. The folder, indicated generally at 20, comprises a first side 24 joined to a second side 28. Sides 24 and 28 can be opened and closed in the general direction indicated by arrow A. The first side 24 includes a pocket having an opening 26 and a top flap 22 closeable over opening 26 in the general direction indicated by arrow B. Importantly, the pocket of side 24 allows an individual to store a variety of memorabilia, including cards, invitations, or other objects. Completed information sheets can also be stored in pocket 30. When the desired objects have been inserted through opening 26 for storage in the pocket, top flap 22 may be closed downward over opening 26. If desired, the top flap 22 may be attached to side 24 for retaining the objects in the pocket. Any retention means known in the art, such as a clasp, hook-and-loop fastener, adhesive, die -cut slot, or other means, could be used to retain top flap 22 to side 24.

Second side 28 could include a bottom flap 30 attached on a side and lower edge thereof to second side 28 to form a second pocket for storing documents, such as the sheets 10 of the present invention. The sheets or other documents can be inserted between second side 28 and bottom flap 30, and remain visible while being stored therein. Importantly, the aforementioned stepped or tiered configuration of sheets 10 allow the subject matter of each of sheets 10 to remain visible while the sheets 10 are stored in the second pocket of folder 20. In a preferred embodiment of the present invention, folder 20 is manufactured from a durable paper product or other archival-quality material known in the art. Alternatively, a flexible material, such as lightweight plastic or any other known material in the art, can be used to provide protection for the articles stored therein and resiliency from spills and other spoils.

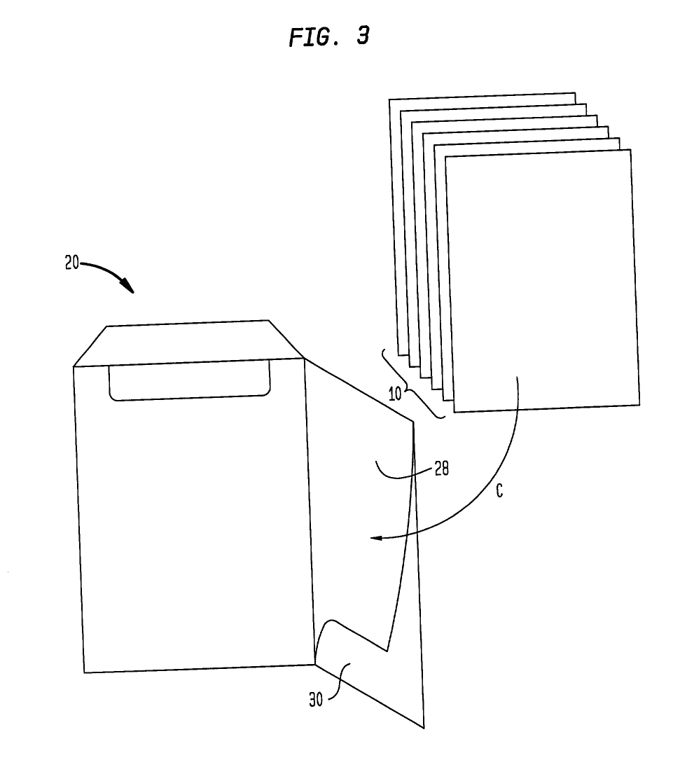

FIG. 3 is a perspective view showing the sheets 10 and the folder 20 of the present invention, the sheets 10 positionable in the folder 20 as shown by arrow C. As illustrated and described in FIG. 1, sheets 10 can be stacked for storage in a stepped or tiered configuration that allows the headings of each of the sheets to remain visible during storage. The tiers could be formed at the upper edges or side edges of the sheets 10. Once the sheets 10 have been arranged and stacked in a desired order, and folder 20 has been opened, the sheets 10 can be inserted between second side 28 and flap 30 in the second pocket of folder 20, along the direction indicated by arrow C, for storage therein. The folder 20 can then be closed.

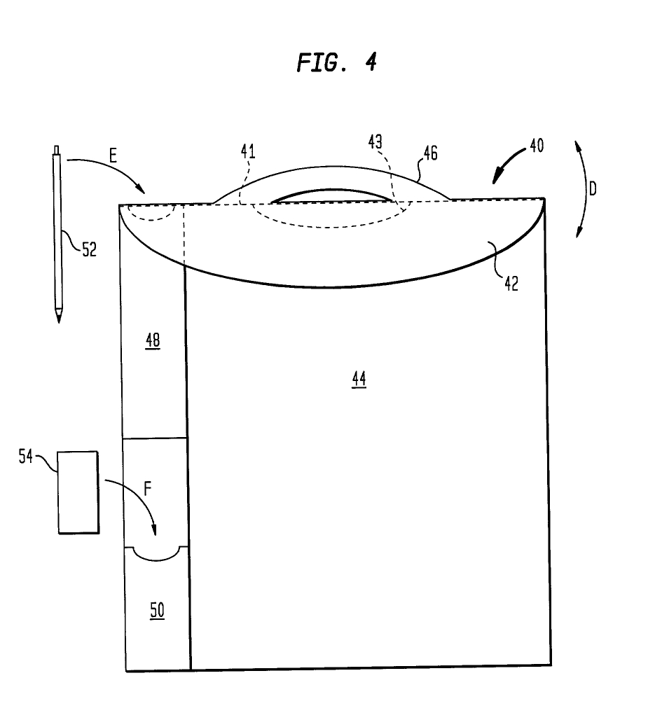

FIG. 4 is a front view of the storage packet of the present invention. The storage packet 40 allows the information sheets and/or one or more of the folders 20 to be stored therein, to provide protection of same and a central location for quickly storing and retrieving same. If desired, the sheets 10 can be removed from the folder 20 and positioned within the storage packet 40, in front of the folder 20, so that the sheets 10 are visible from the exterior of the storage packet 40. In a preferred embodiment of the invention, storage packet 40 is manufactured from lightweight, flexible vinyl, and is resilient to spills and other spoils. Any other material known in the art, however, may be utilized to construct storage packet 40. Storage packet 40 may include a flap 42. Alternatively, it may be desirable to remove the top flap, or tuck it into the packet, to facilitate accessing the packet. Accordingly, the top flap maybe provided with perforations or a score line 41 at its point of attachment to allow for the removal thereof. A cutout 43, shown in phantom, can be provided to allow easy insertion and removal of items into and out of packet 40. One or more of the folders 20, or other objects, can be inserted into packet body 44 and retained therein. The flap 42 if used, can be closed by moving it in the direction generally indicated by arrow D. An adhesive or other means may be used to retain the flap if used, against the packet to close the packet. Further, a handle 46 may be provided for transporting the storage packet 40, or hanging same at a desired location, such as in a retail store or in the home.

Storage packet 40 may also include one or more supplemental pockets disposed on packet body 44 for holding a writing implement or other object. As shown in FIG. 4, external pockets 48 and 50 are disposed near the left side of packet body 44, but it is to be understood that any spatial arrangement of pockets 48 and 50 with relation to packet body 44 is considered within the scope of the invention. Pocket 48 can store a writing instrument 52 (which may be a pen, pencil, or any other known writing implement), while pocket 50 can store an identification card 54 or other object. Writing instrument 52 can be inserted into pocket 48 along the general direction indicated by arrow E for storage therein. Similarly, the identification card 54 can be inserted into pocket 50 along the general direction indicated by arrow F. The title or other identifier can be placed on the card to identify the person about whom information is being collected. It should be understood that any number and arrangement of external pockets attached to packet body 44 are considered within the scope of the present invention.

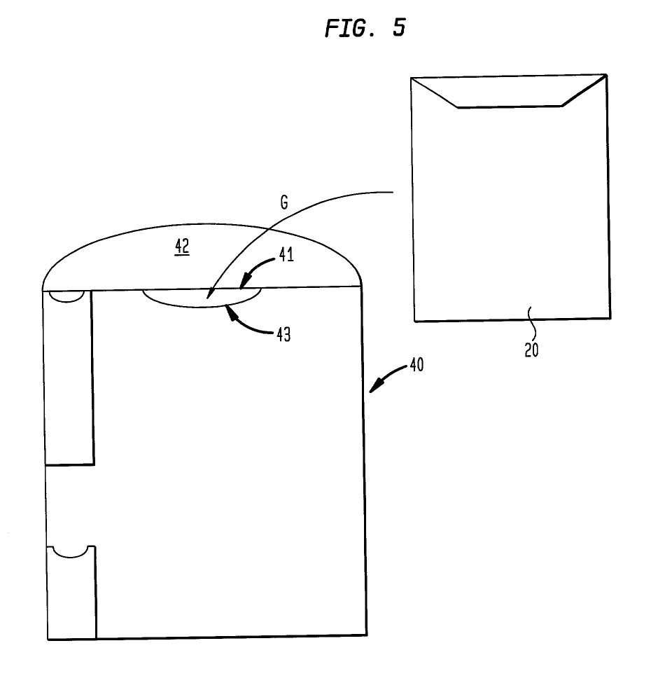

FIG. 5 is a front view of the folder 20 and the storage packet 40 of the present invention, the folder positionable in the storage packet as shown by arrow G. Any number of folders 20 can be stored in storage packet 40, which provides protection of the folders and a central storage and retrieval location. When a user desires to store one or more of the folders 20 in storage packet 40, the top flap 42 (if still attached to the packet) of storage packet 40 is first opened. Then, one or more of the folders 20 are gathered together and inserted into storage packet 40 along the direction indicated generally by arrow G. The cutout 43 can be provided on the packet 40 to allow easy access, insertion, and removal of the folders 20, or other items, from packet 40. Once the folders 20 have been inserted therein, the top flap 42 may be closed downward and attached to the body of storage packet 40 to retain the one or more folders 20 within storage packet 40. It should be noted that the present invention could be practiced without a folder; i.e., the sheets could be placed directly in the storage packet. It should also be pointed out that the storage packet 40 is preferably made of a transparent material and/or folder 20 could be transparent to allow for sheets 10 to be viewed from the exterior thereof.

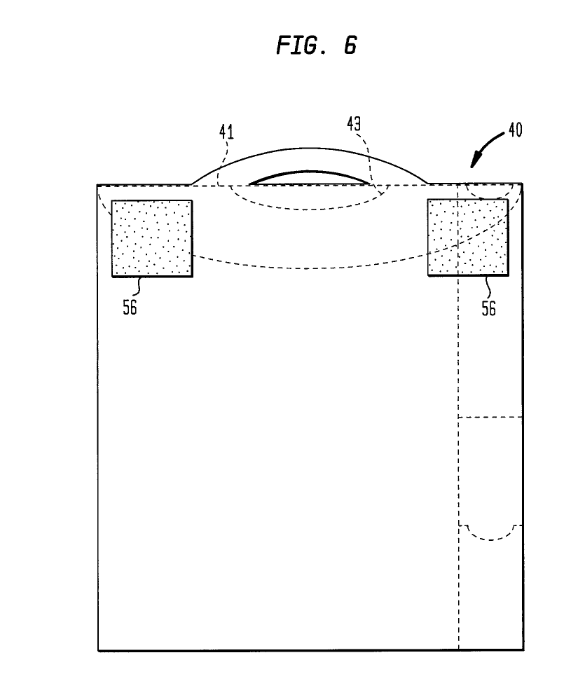

FIG. 6 is a rear view of the storage packet of the present invention, showing an illustrative embodiment of the apparatus for attaching the storage packet to a surface. Storage packet 40 can be attached to any convenient surface, such as a refrigerator door, cabinet door, wall, or other surface, using attachment means 56. In a preferred embodiment of the present invention, attachment means 56 comprises an adhesive, such as the adhesive sold under the trademark COMMAND manufactured by the Minnesota Mining and Manufacturing (3M) Company. A towelette or pre-moistened pad containing rubbing alcohol, could be provided for cleaning a surface prior to contacting the adhesive thereto. Preferably, attachment means 56 allow the storage packet 40 to be easily attached, hung, and later removed from a desired surface without damaging the surface, the storage packet or the contents thereof. Other attachment means, such as hook-and-loop fasteners, magnets, or any other suitable apparatus known in the art, can be utilized by the present invention. Further, attachment means 56 are preferably disposed near the top edges of the backside of storage packet 40, but other locations and orientations are considered within the scope of the invention. It should be noted that the system could be used without attachment to a surface (i.e., the packet could be closed and stored on a flat surface or in a drawer).

An archival-safe bag, manufactured of polyethylene or other similar material, may be provided to allow for long-term storage of the present invention. For example, when all desired sheets have been filled out with information, and the user would like to archive the sheets, he or she could insert the sheets into the folder of the present invention, in addition to any other desired memorabilia, and insert the folder into the archival-safe bag. Alternatively, the sheets could be inserted directly into the archival-safe bag.

FIGS. 7a-7b are views of the front and back sides of an information sheet of the present invention for recording information pertaining to the birth of a child. The front side of the sheet, shown in FIG. 7a, contains the title “Welcome to the world!” and contains numerous spaces in which information about a child's birth can be recorded. For example, a parent may record information about the child's date of birth, time of arrival, weight, height, and other information. The rear side of the sheet, shown in FIG. 7b, contains spaces for entering additional information relating to the child's birth.

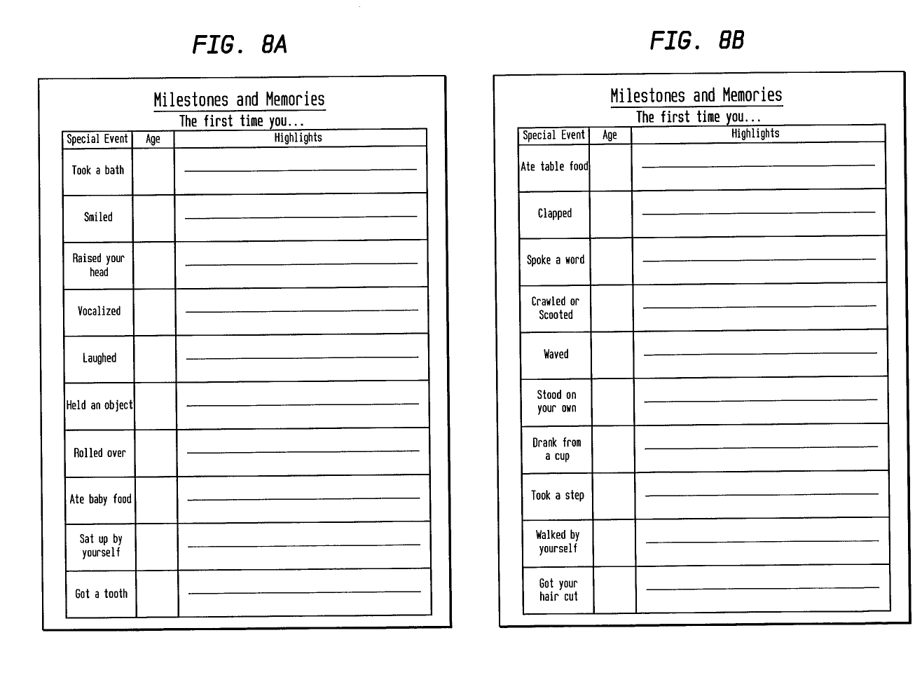

FIGS. 8a-8b are views of the front and back sides of another information sheet of the present invention for recording information pertaining to childhood memories. The front side of the sheet, shown in FIG. 8a, contains the title “Milestones and Memories” and contains a list of numerous milestones and special events with corresponding spaces in which information about the milestones and events in a child's life can be recorded. For example, a parent could record information about the child's first spoken words, the first time that the child crawled, the time the child took its first step, and the first haircut, etc. The rear side of the sheet, shown in FIG. 8b, contains spaces for entering additional information relating to memorable events in the child's life.

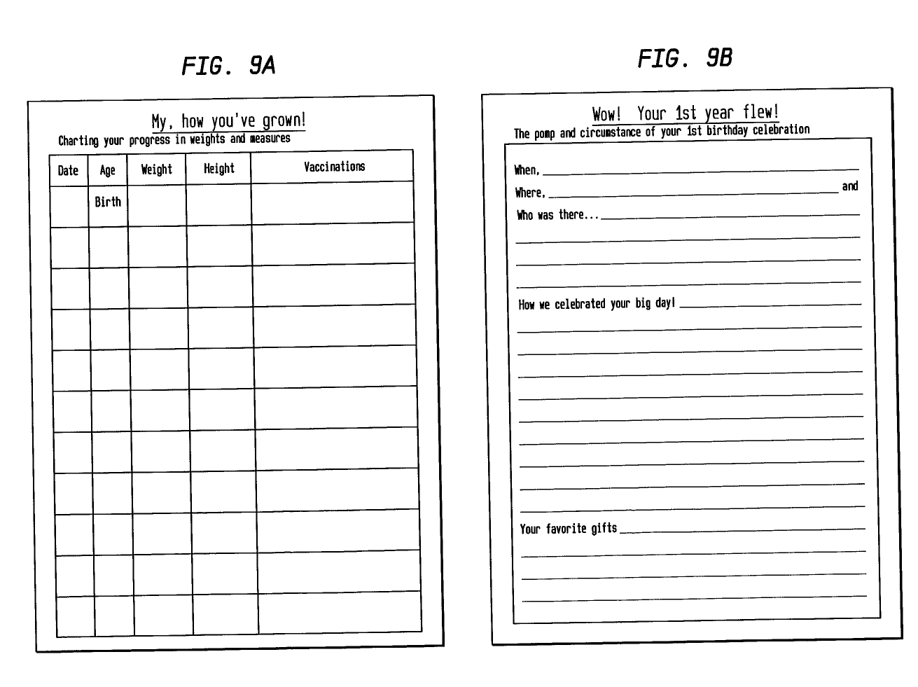

FIGS. 9a-9b are views of the front and back sides of another information sheet of the present invention for recording information pertaining to a child's physical growth and first birthday. The front side of the sheet, shown in FIG. 9a, contains the title “My, how you've grown” and contains numerous spaces in which information about a child's physical growth can be recorded. For example, a parent may record information about the child's age, weight, height, and vaccinations at various dates. The rear side of the sheet, shown in FIG. 9b, contains spaces for entering additional information relating to the child's first birthday celebration.

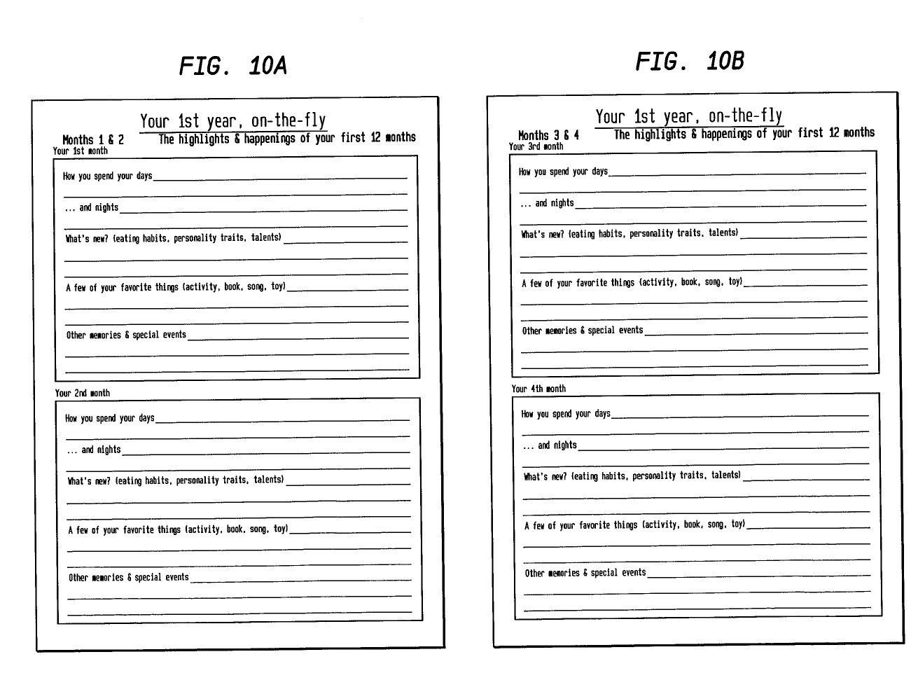

FIGS. 10a-10b are views of the front and back sides of another information sheet of the present invention for recording information pertaining to the first four months of the child's first year. The front side of the sheet, shown in FIG. 10a, contains the title “Your 1^{st} year, on-the-fly” and contains numerous spaces in which information about events occurring in the first and second months of the child's life. For example, a parent may record information about the child's activities, preferences, and special occasions occurring during the first and second months of the child's life. The rear side of the sheet, shown in FIG. 10b, contains spaces for entering information relating to events occurring in the child's third and fourth months.

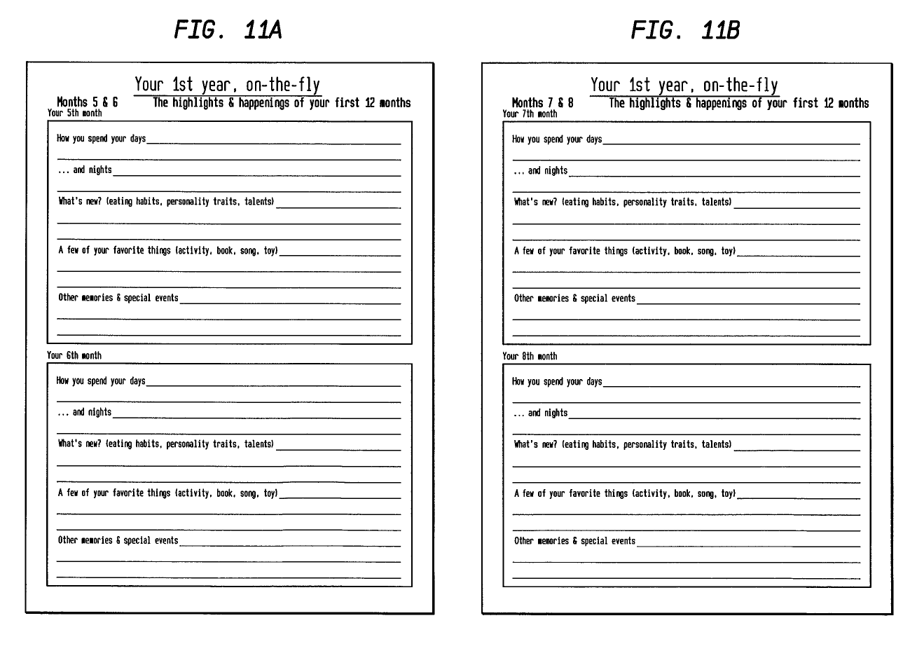

FIGS. 11a-11b are views of the front and back sides of another information sheet of the present invention for recording information pertaining to the next four months of the child's first year. The front side of the sheet, shown in FIG. 11a, contains the title “Your 1^{st} year, on-the-fly” and contains numerous spaces in which information about events occurring in the fifth and sixth months of the child's life. For example, a parent may record information about the child's activities, preferences, and special occasions occurring during the fifth and sixth months of the child's life. The rear side of the sheet, shown in FIG. 11b, contains spaces for entering information relating to events occurring in the child's seventh and eighth months.

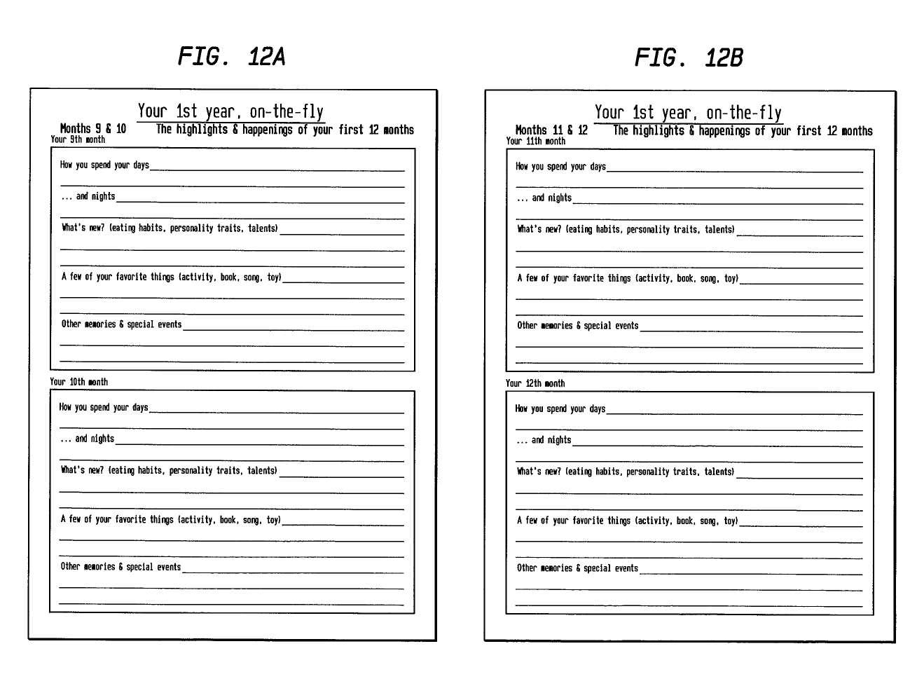

FIGS. 12a-12b are views of the front and back sides of another information sheet of the present invention for recording information pertaining to the last four months of the child's first year. The front side of the sheet, shown in FIG. 12a, contains the title “Your 1^{st} year, on-the-fly” and contains numerous spaces in which information about events occurring in the ninth and tenth months of the child's life. For example, a parent may record information about the child's activities, preferences, and special occasions occurring during the ninth and tenth months of the child's life. The rear side of the sheet, shown in FIG. 12b, contains spaces for entering information relating to events occurring in the child's eleventh and twelfth months.

It is to be understood that the foregoing description of the sheets of the present invention, illustrated in FIGS. 7a-12b, is not intended to limit the scope thereof. Any desired information can be recorded on the sheets of the present invention without departing from the spirit thereof. The titles of the sheets, in addition to the contents and text thereof, can be varied as desired. Further, it is conceivable that additional sheets can be provided for recording additional personal information, such as events occurring in successive years of a child's life, including toddler development, academic honors, extracurricular activities, etc. Other packages could be developed for record keeping in other areas. For example, an automotive package could be developed for tracking information related to an automobile. Specific sheets could be tailored for such an application. The subject matter for such packages is virtually endless.

Having thus described the invention in detail, it is to be understood that the foregoing description is not intended to limit the spirit and scope thereof. What is desired to be protected by Letters Patent is set forth in the appended claims.

What is claimed is:

1. A personal information recording system comprising:
a plurality of information sheets for recording information, each of the sheets formatted for recording particular information;
a storage packet for storing the plurality of sheets and for holding additional relevant material; and
means for attaching the storage packet to a vertical surface.

2. The system of claim 1, further comprising a folder for storing the plurality of sheets, the folder positionable within the storage packet.

3. The system of claim 1, wherein each of the plurality of sheets comprises a plurality of areas for recording information about one or more events.

4. The system of claim 1, wherein each of the plurality of sheets comprises a title for indicating subject matter of the sheets.

5. The system of claim 4, wherein each of the plurality of sheets are stepped in size and tiered so that the titles thereof can be viewed.

6. The system of claim 1, wherein the plurality of sheets comprise archival quality paper.

7. The system of claim 1, wherein the particular information pertains to events in a person's life, such as events in a child's life.

8. The system of claim 2, wherein the folder comprises a first pocket for storing one or more of the plurality of sheets and a second pocket for storing memorabilia.

9. The system of claim 1, wherein the storage packet comprises a pocket for holding a writing instrument.

10. The system of claim 1, wherein the storage packet comprises a second pocket for holding an identification card.

11. The system of claim 1, further comprising means for attaching the storage packet to a surface.

12. The system of claim 1, wherein the storage packet further comprises a flap engageable with the storage packet for retaining one or more of the folders or information sheets within the storage packet.

13. The system of claim 12, wherein the flap comprises retaining means for engaging the flap with the storage packet.

14. The system of claim 1, further comprising means for attaching the storage packet to a surface.

15. The system of claim 2, further comprising a storage bag for storing the plurality of sheets, the storage packet, or the folder.

16. An apparatus for recording information about a person's life comprising:
a plurality of information sheets stepped in size and having edges, the sheets pre-formatted for recording relevant information about the person's life;
title areas located along the edges of the sheets, the title areas indicating the subject matter of the sheets and being visible when the sheets are stacked together; and
a plurality of areas on the plurality of sheets for recording information about desired events.

17. The apparatus of claim 16, further comprising a writing apparatus for recording information on the plurality of pre-formatted sheets.

18. The apparatus of claim 17 further comprising a storage packet for holding the plurality of information sheets.

19. The apparatus of claim 18 further comprising one or more folders for holding the plurality of sheets, the one or more folders sized to be held by the storage packet.

20. The apparatus of claim 16, wherein the information relates to events in a child's life.

21. A method for recording personal information comprising:
providing a plurality of information sheets stepped in size for recording personal information;
writing information about a desired event on one or more of the plurality of sheets;
storing the sheets in a storage packet; and
attaching the storage packet to a surface.

22. The method of claim 21, further comprising storing an article of memorabilia in the storage packet.

23. The method of claim 21, further comprising:
locating a desired sheet from the storage packet by selecting a sheet from a plurality of sheets having visible titles;
removing the desired sheet from the storage packet;
recording information on the desired sheet; and
returning the desired sheet back into the storage packet.

24. The method of claim 23, further comprising storing information sheets in one or more folders, and storing the one or more folders in the storage packet.

25. The method of claim 21, wherein the step of writing information comprises writing information about events in a person's life on one or more of the plurality of sheets.
